(19) United States
(12) Patent Application Publication
(10) Pub. No.: US 2025/0238505 A1
(43) Pub. Date: Jul. 24, 2025

(54) AUTOMATIC REMEDIATION OF SECURITY AGENTS

(71) Applicant: SAUDI ARABIAN OIL COMPANY, Dhahran (SA)

(72) Inventor: Dana Baghabrah, Dammam (SA)

(73) Assignee: SAUDI ARABIAN OIL COMPANY, Dhahran (SA)

(21) Appl. No.: 18/421,600

(22) Filed: Jan. 24, 2024

(51) Int. Cl. G06F 21/55; G06F 21/57

(52) U.S. Cl. CPC G06F 21/554; G06F 21/577

(57) ABSTRACT

Methods and systems are disclosed. The methods may include detecting a first missing or corrupted agent installed on a first machine, determining a first service associated with the first missing or corrupted agent is non-operational, restarting the first service on the first machine, redetecting the first missing or corrupted agent installed on the first machine, and reimaging the first machine. The methods may further include detecting a second missing or corrupted agent installed on a second machine, determining a second service associated with the second missing or corrupted agent is operational, reinstalling the second missing or corrupted agent on the second machine, redetecting the second missing or corrupted agent installed on the second machine, and reimaging the second machine. Automatic remediation includes restarting, reinstalling, and reimaging. The systems may include a server and automatic remediation machine communicably coupled to one another.

### BACKGROUND

As computers advance and become more heavily relied on, cybersecurity must also advance to mitigate security-related threats such as cyberattacks. Data analytics may be used to advance cybersecurity. Data analytics is the process of converting raw data into actionable insights. Data analytics may be especially useful in mid-size to large organizations that own tens to thousands of computers each of which are prone to security-related threats.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments relate to a method. The method includes detecting a first missing or corrupted agent installed on a first machine, determining a first service associated with the first missing or corrupted agent is non-operational, and restarting the first service on the first machine. The method further includes redetecting the first missing or corrupted agent installed on the first machine and reimaging the first machine. Automatic remediation includes restarting and reimaging.

In general, in one aspect, embodiments relate to a method. The method includes detecting a first missing or corrupted agent installed on a first machine, determining a first service associated with the first missing or corrupted agent is operational, and reinstalling the first missing or corrupted agent on the first machine. The method further includes redetecting the first missing or corrupted agent installed on the first machine and reimaging the first machine. Automatic remediation includes reinstalling and reimaging.

In general, in one aspect, embodiments relate to a system. The system includes a server and an automatic remediation machine communicably coupled to one another. The server is configured to detect a first missing or corrupted agent installed on a first machine. The server is further communicably coupled to the first machine. The automatic remediation machine is configured to determine a first service associated with the first missing or corrupted agent is non-operational and restart the first service on the first machine. The server is further configured to redetect the first missing or corrupted agent installed on the first machine. The automatic remediation machine is further configured to reimage the first machine. Automatic remediation includes to restart and reimage.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 displays a flowchart in accordance with one or more embodiments.

FIG. 2 displays one or more databases and/or repositories in accordance with one or more embodiments.

FIG. 3 displays a flowchart in accordance with one or more embodiments.

FIGS. 4 and 5 each describe a method of automatic remediation in accordance with one or more embodiments.

FIG. 6 illustrates a machine in accordance with one or more embodiments.

FIG. 7 illustrates a system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. Thus, for example, reference to “an agent” includes reference to one or more of such agents.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope disclosed herein should not be considered limited to the specific arrangement of steps shown in the flowcharts.

Although multiple dependent claims are not introduced, it would be apparent to one of ordinary skill that the subject matter of the dependent claims of one or more embodiments may be combined with other dependent claims.

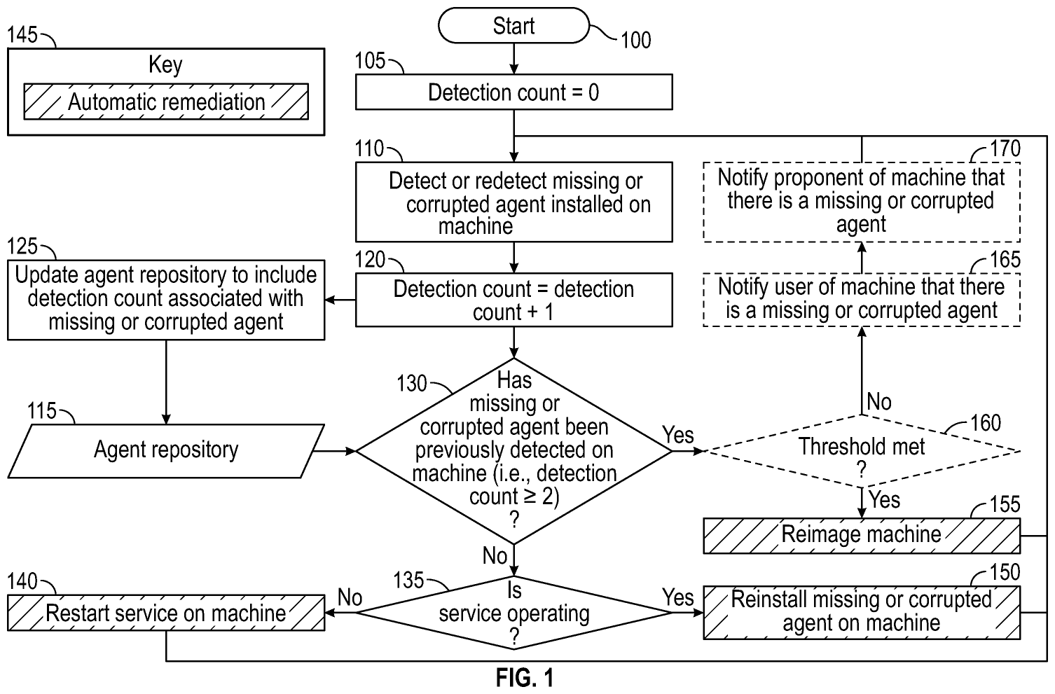

In the following description of FIGS. 1-7, any component described regarding a figure, in various embodiments disclosed herein, may be equivalent to one or more like-named components described regarding any other figure. For brevity, descriptions of these components will not be repeated regarding each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described regarding a corresponding like-named component in any other figure.

Data analytics methods and systems are disclosed to automatically monitor and remediate one or more missing or corrupted agents installed on one or more machines. In some embodiments, each missing or corrupted agent may be a missing or corrupted software security agent (hereinafter “missing or corrupted security agent”). Accordingly, the data analytics methods and systems may dynamically maintain one or more security agents. A security agent may be a specialized software component that performs security-related actions on the machine. The security agent may be or include, without limitation, an anti-virus agent, application whitelisting agent, data leakage prevention (DLP) agent, and vulnerability scanning agent (e.g., Nessus agent). Security-related actions may include, without limitation, security scanning and reporting, system restarting and rebooting, applying software patches, changing configurations, and general system monitoring. Further, in some embodiments, the machine may be a computer system or server.

In some embodiments, the disclosed methods and systems may dynamically maintain each missing or corrupted agent by automatically remediating each missing or corrupted agent based on if service associated with the missing or corrupted agent is operating on the machine that the missing or corrupted agent is installed on and if the missing or corrupted agent has been detected on the machine previously. In some embodiments, the disclosed methods and systems may further automatically and electronically notify a user and/or proponent of each machine that a missing or corrupted agent is installed on the machine and/or automatically generate a trouble ticket.

The data analytics methods and systems are motivated by the idea that it is time consuming, difficult, costly, and ineffective to manually evaluate and remediate each missing or corrupted agent installed on each machine owned by a mid-size to large organization. Especially as mid-size to larger organizations are only able to employ a small number of proponents (e.g., information technology (IT) analysts and security team personnel) compared to the large number of machines the proponents are required to maintain. Further, manual evaluation and remediation may cause unnecessary downtime as a user of each machine waits for each missing or corrupted agent to be remediated by a proponent. Accordingly, user downtime may negatively affect the ability of the proponent to work if feeling pressured by the user to evaluate and remediate each missing or corrupted agent quickly so that the user may get back to work.

If applied to missing or corrupted security agents, the data analytics methods and systems may reduce the risk of a missing or corrupted security agent going undetected and/or unremediated on a machine. The data analytics methods and systems may further reduce the amount of time the missing or corrupted security agent remains undetected and/or unremediated. Therefore, the data analytics methods and systems may increase the overall software security associated with the organization that owns the machines and reduce the risk of each machine being vulnerable to security-related threats such as cyberattack. By way of example, it may take on the order of days or weeks for a proponent to manually investigate and find one or more machines with one or more missing or corrupted agents and generate one or more trouble tickets or incidents for other proponents to resolve and apply remediations. Whereas the disclosed data analytics methods and systems may reduce the process to an order of minutes or hours. Further, the cost savings may be on the order of hundreds of dollars daily, thousands of dollars weekly and monthly, and hundreds of thousands of dollars annually depending on the number of machines within the organization and the number of proponents required to maintain those machines. Further still, certain security-related systems may limit the number of trouble tickets that may be generated each day even though the true number of trouble tickets that need to be generated exceed the limit. However, other ideas may also motivate the disclosed systems and methods.

Accordingly, the disclosed data analytics methods and systems may be an improvement over other methods and systems as the disclosed data analytics methods and systems may reduce the time and cost associated with and increase the ease and effectiveness of the remediation of each missing or corrupted agent.

In practice, each missing or corrupted agent may be a missing or corrupted security agent, where one or more security agents are installed on one or more machines. In some embodiments, each machine may be or include a computer system. The data analytics system may include a server communicably coupled to tens to thousands of machines. The server may be configured to automatically detect each missing or corrupted agent installed on the one or more machines.

The server may be further communicably coupled to an automatic remediation machine. The automatic remediation machine may be configured to determine if service associated with each missing or corrupted agent is operational or non-operational and determine if the missing or corrupted agent has occurred previously on the machine or not based, in some embodiments, on an agent repository. Accordingly, the automatic remediation machine may be further configured to dynamically maintain the missing or corrupted agent by automatically remediating the missing or corrupted agent based on if service is operational or non-operational and if the missing or corrupted agent has occurred previously.

FIG. 1 displays a flowchart in accordance with one or more embodiments. The flowchart describes methods of dynamic maintenance of an agent installed on a machine that is missing or corrupted by automatic remediation and notification of the agent. Each block within FIG. 1 may be performed automatically without user and/or proponent intervention.

To start 100, a detection count is set to zero or a previous detection count as shown by process block 105 as the missing or corrupted agent has yet to be detected. The missing or corrupted agent is detected as shown by process block 110. The detection count is increased by one and updated within an agent repository 115 as shown by process blocks 120 and 125. A decision is made based on the detection count stored within the agent repository 115 as to if the missing or corrupted agent has been previously detected on the machine as shown by decision block 130. In some embodiments, decision block 130 may be performed by searching the agent repository 115 for the missing or corrupted agent and comparing the current detection count associated with the missing or corrupted agent to a previous detection count associated with the missing or corrupted agent. In some embodiments, the previous detection count may only include the detection count associated with a past time interval like the previous week. If a match for the missing or corrupted agent is not found within the agent repository 115 (i.e., the current detection count is less than two), a decision is made based on service associated with the missing or corrupted agent as shown by decision block 135. If the service is non-operational, the missing or corrupted agent is automatically remediated by restarting the service on the machine as shown by process block 140 and key 145. If the missing or corrupted agent is redetected on the machine as shown by process block 110, the method continues iteratively as shown in FIG. 1.

If the service is operational, the missing or corrupted agent is automatically remediated by reinstalling the missing or corrupted agent on the machine as shown by process block 150 and key 145. If the missing or corrupted agent is redetected on the machine as shown by process block 110, the method continues iteratively as shown in FIG. 1.

Returning to decision block 130, if a match for the missing or corrupted agent is found within the agent repository 115 (i.e., the missing or corrupted agent has been redetected on the machine as the current detection count is greater than or equal to two), the missing or corrupted agent is automatically remediated by reimaging the machine as shown by process block 155. If the missing or corrupted agent is again redetected on the machine as shown by process block 110, the method continues iteratively as shown in FIG. 1.

In other embodiments, if the missing or corrupted agent has been previously detected on the machine and is redetected, the detection count must be greater than or equal to a threshold for automatic remediation of reimaging the machine as shown by decision block 160 and process block 155. In these embodiments, the threshold may be a predefined integer, such as seven. In these embodiments, if the threshold is not met, a user and/or proponent of the machine may be electronically notified that there is a missing or corrupted agent installed on the machine as shown by process blocks 165 and 170 and the method continues iteratively as shown in FIG. 1. In some embodiments, electronic notification may be in the form of a trouble ticket (i.e., alert) sent via short messaging service (SMS), email, or other electronic means. In some embodiments, the proponent may be an IT analyst or security team personnel.

Accordingly, methods of automatic remediation may include, without limitation, restarting service on the machine with the missing or corrupted agent, reinstalling the missing or corrupted agent on the machine, and reimaging the machine with the missing or corrupted agent as shown by process blocks 140, 150, and 155 and key 145. However, a person of ordinary skill in the art will appreciate that other methods of automatic remediation may be used and based on other decision blocks not included in FIG. 1.

Further, while FIG. 1 describes methods of automatic remediation for one missing or corrupted agent installed on one machine, the methods described in FIG. 1 may be operating in series or parallel for each missing or corrupted agent installed on each machine within an organization. Further still, one iteration may be repeated based on a periodic cycle, which may be on the order of minutes, hours, days, or weeks.

Turning to the agent repository 115, the agent repository 115 may store or include the detection count associated with each missing or corrupted agent installed on each machine. In other words, the agent repository 115 includes the detection history of each missing or corrupted agent installed on each machine. In some embodiments, the agent repository 115 may further include information about each machine, each user of each machine, and/or each missing or corrupted agent or be communicably coupled to one or more databases and/or repositories that include the information thereof.

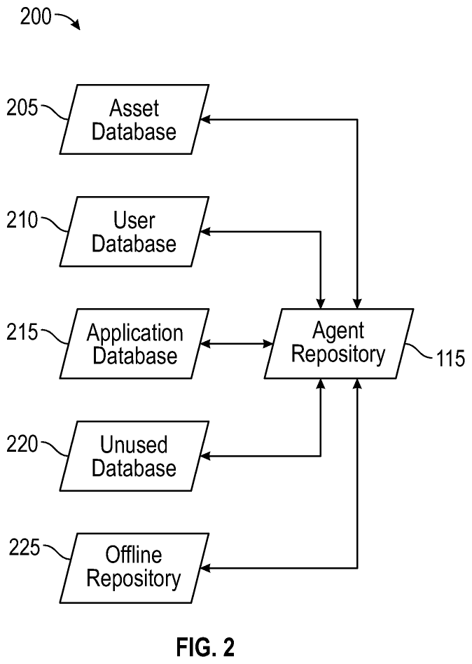

FIG. 2 displays one or more databases and/or repositories 200 in accordance with one or more embodiments. In some embodiments, an asset database 205 may include information about each machine (i.e., asset) such as, without limitation, asset owner, asset status, asset location, asset description, and asset type (e.g., critical asset, mobility asset, and legal asset). In some embodiments, a user database 210 may include information about each user (e.g., employee) of each machine such as, without limitation, user network identification, user department, user phone number, and user type (e.g., critical employee). In some embodiments, an application database 215 may include information about each missing or corrupted agent such as, without limitation, machine name and connection status. In some embodiments, an unused database 220 may include information about one or more machines that are currently unused. In some embodiments, an offline repository 225 may include information about one or more machines that are offline. In these embodiments, the offline repository 225 may be used, at least in part, to check the connection status of each offline machine at periodic points in time, such as every three days. Hereinafter, the term “information” may refer to any information as described immediately above in any of the databases and/or repositories 200 among additional information.

Each database and/or repository may be communicably coupled to any other database and/or repository. Though, FIG. 2 specifically displays the asset database 205, user database 210, application database 215, unused database 220, and offline repository 225 communicably coupled to the agent repository 115. However, a person of ordinary skill in the art will appreciate that other configurations that include other databases and/or repositories may be used without departing from the scope of the disclosure.

Though not shown in FIG. 2, a data analytics module may be the process of collecting and storing the information within the one or more databases and/or repositories 200.

As shown in FIG. 1 as the agent repository 115, the one or more databases and/or repositories 200 may be accessed to write the detection count and other information associated with each missing or corrupted agent to the one or more databases and/or repositories 200. Further, the one or more databases and/or repositories 200 may be read to, for example, determine if each missing or corrupted agent has been previously detected on each machine as shown by decision block 130.

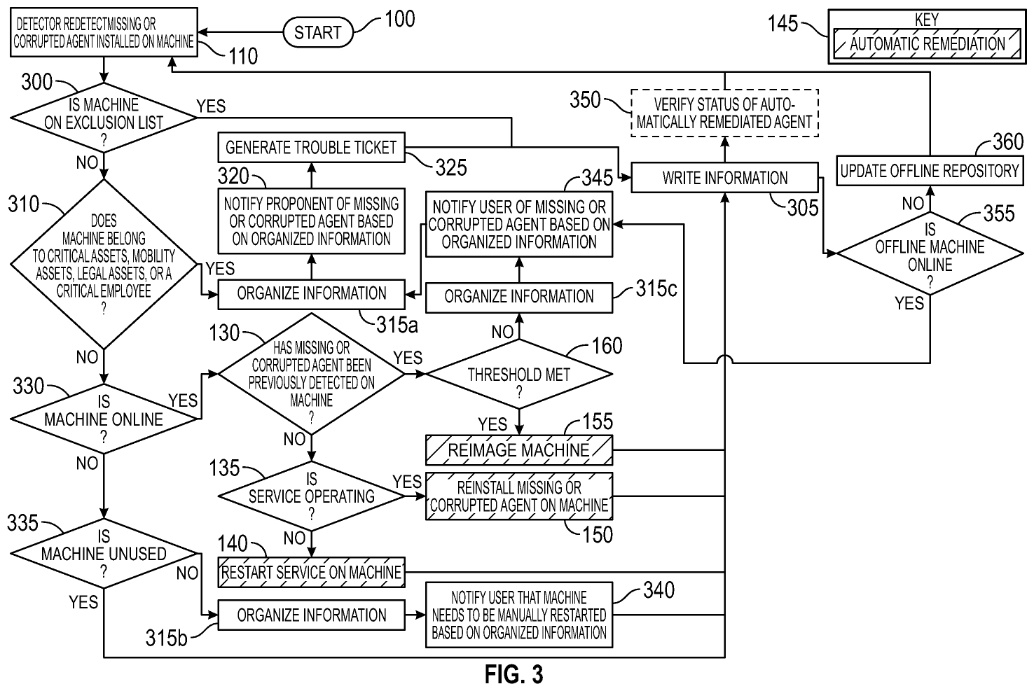

FIG. 3 displays a flowchart in accordance with one or more embodiments. The flowchart describes methods of dynamic maintenance of an agent installed on a machine that is missing or corrupted by automatic remediation and notification of the agent. Each block within FIG. 3 may be performed automatically without user and/or proponent intervention. Further, while FIG. 3 describes methods of automatic remediation for one missing or corrupted agent installed on one machine, the methods described in FIG. 3 may be operating in series or parallel for each missing or corrupted agent installed on each machine.

The flowchart in FIG. 3 may be considered a more practical application of the disclosed methods relative to FIG. 1.

To start 100, a missing or corrupted agent is detected on a machine as shown by process block 110. A decision is made as to if the machine is on an exclusion list as shown by decision block 300. In some embodiments, a machine on the exclusion list may intentionally have one or more missing or corrupted agents installed on the machine such that the machine may be used for testing purposes. In some embodiments, the exclusion list may be stored on the one or more databases and/or repositories 200. If the machine is on the exclusion list, information associated with the machine, user of the machine, and/or missing or corrupted agent may be written to the one or more databases and/or repositories 200 as shown by process block 305.

If the machine is not on the exclusion list, a decision is made as to if the machine belongs to critical assets, mobility assets, legal assets, or a critical employee as shown by decision block 310. If the machine does belong to critical assets, mobility assets, legal assets, or a critical employee, information associated with the machine, user of the machine, and/or missing or corrupted agent may be organized as shown by process block 315a, a proponent (e.g., IT analyst) is electronically notified of the missing or corrupted agent installed on the machine as shown by process block 320 where the electronic notification includes the organized information, and a trouble ticket is generated as shown by process block 325. In these embodiments, each missing or corrupted agent installed on each machine that belongs to critical assets, mobility assets, legal assets, or a critical employee may be automatically, semi-automatically, or manually remediated by a separate group of proponents. Accordingly, each missing or corrupted agent installed on each machine that belongs to critical assets, mobility assets, legal assets, or a critical employee may not be automatically remediated based on the flowchart shown in FIG. 3. In some embodiments, the organized information may include the name of the proponent notified and computer list. In some embodiments, the computer list may include a list of one or more machines that belong to critical assets, mobility assets, and/or legal assets. Further, in some embodiments, the computer list may be included within the asset database 205.

If the machine does not belong to critical assets, mobility assets, legal assets, or a critical employee, a decision is made as to if the machine is online as shown by decision block 330. In some embodiments, if the online/offline status of the machine has changed, the offline repository 225 may be updated to reflect the current offline/online status of the machine. If the machine is not online (i.e., offline), a decision is made as to if the machine is unused as shown by decision block 335. In some embodiments, determination of if the machine is unused may be based on the unused database 220. If the machine is unused, information associated with the machine, user of the machine, and/or missing or corrupted agent may be written to the one or more databases and/or repositories 200 as shown by process block 305. If the machine is not unused (i.e., used), information associated with the machine, user of the machine, and/or missing or corrupted agent may be organized as shown by process block 315b and a user of the machine is electronically notified that the machine needs to be manually restarted (or a remote session is necessary) as shown by process block 340 where the electronic notification includes the organized information, and the organized information is written to the one or more databases and/or repositories 200 shown by process block 305. In some embodiments, the organized information sent to the user may include asset identification, owner network identification, and owner name.

Returning to decision block 330, if the machine is online, a decision is made as to if the missing or corrupted agent has been previously detected on the machine as shown by decision block 130. In some embodiments, previous detection of the missing or corrupted agent may be determined based on the one or more databases and/or repositories 200 (e.g., the agent repository 115) that store the number of times the missing or corrupted agent has been detected (i.e., detection count) on the machine.

If the missing or corrupted agent has not been previously detected on the machine within the past time interval, a decision is made as to if service associated with the missing or corrupted agent is operating on the machine as shown by decision block 135. If the service is non-operational, the missing or corrupted agent is automatically remediated by restarting the service on the machine as shown by process block 140 and key 145. If the service is operational, the missing or corrupted agent is automatically remediated by reinstalling the missing or corrupted agent on the machine as shown by process block 150 and key 145.

Returning to decision block 130, if the missing or corrupted agent has been previously detected on the machine within the past time interval and is redetected, a decision is made as to if the number of detections (i.e., detection count) meets a threshold as shown by decision block 160. If the number of detections meets the threshold, the missing or corrupted agent is automatically remediated by reimaging the machine as shown by process block 155 and key 145. If the number of detections does not meet the threshold, information associated with the machine, user of the machine, and/or missing or corrupted agent may be organized as shown by process block 315c, a user of the machine is electronically notified of the missing or corrupted agent as shown by process block 345 where the electronic notification includes the organized information, information associated with the machine, user of the machine, and/or missing or corrupted agent is organized as shown by process block 315a, a proponent (e.g., IT analyst) is electronically notified of the missing or corrupted agent installed on the machine as shown by process block 320 where the electronic notification includes the organized information, and a trouble ticket is generated as shown by process block 325.

Following the writing of information to the one or more databases and/or repositories 200 as shown by process block 305, if applicable, the status of the automatically remediated agent is verified as shown by process block 350 to ensure the automatically remediated agent is operating adequately (i.e., not missing or corrupted). In some embodiments, the automatically remediated agent may be verified based on a dynamically-generated report. In some embodiments, the dynamically-generated report may be re-generated based on a periodic cycle that may be on the order of minutes, hours, days, or weeks. However, in some embodiments, the detected and/or redetected missing or corrupted agent has not been automatically remediated prior to process block 350.

Further, following the writing of information as shown by process block 305, a decision is made based on if the previously-offline machine is online or offline as shown by process block 355. If the previously-offline machine is online, a user of the machine may be notified that a missing or corrupted agent is installed on the now-online machine as shown by process block 345 and the methods continue iteratively as shown in FIG. 3. If the previously-offline machine remains offline, the offline repository 225 is updated as shown by process block 360 and the methods continue iteratively as shown in FIG. 3.

Following the completion of process blocks 305, 350, and/or 360, the methods may continue iteratively as shown in FIG. 3 beginning by redetected the missing or corrupted agent as shown in process block 110. Further, the methods described in FIG. 3 may continue iteratively indefinitely for each missing or corrupted agent installed on each machine based on the periodic cycle. In other words, for example, the methods described in FIG. 3 may be repeated every one or more minutes, hours, days, or weeks.

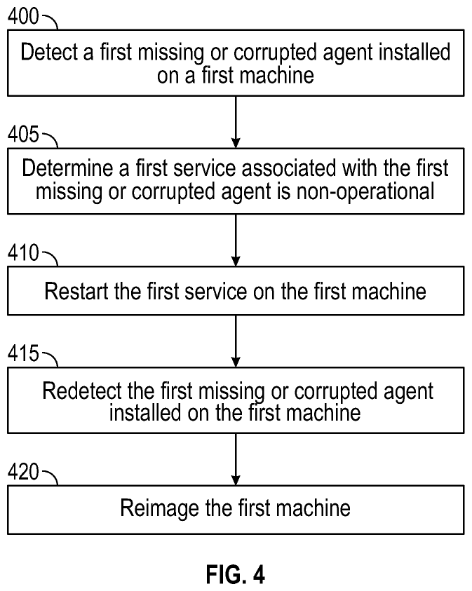

FIG. 4 describes a method in accordance with one or more embodiments. In step 400, a first missing or corrupted agent installed on a first machine is detected as shown in process block 110 in FIGS. 1 and 3. In some embodiments, a server may detect the first missing or corrupted agent. In some embodiments, the first missing or corrupted agent may be a first missing or corrupted security agent. Accordingly, the security of the first machine may be compromised due to the first missing or corrupted security agent.

In step 405, a first service associated with the first missing or corrupted agent is determined to be non-operational as shown in decision block 135 in FIGS. 1 and 3. In some embodiments, an automatic remediation machine may determine the first service is non-operational. In some embodiments, the first service may be an action the first missing or corrupted agent is configured to perform on the first machine. If the first missing or corrupted agent is a first missing or corrupted security agent, the first service may be a security-related action.

In step 410, the first missing or corrupted agent is automatically remediated by restarting the first service on the first machine as shown by process block 140 in FIGS. 1 and 3. In some embodiments, the automatic remediation machine may automatically remediate the first missing or corrupted agent by restarting the first service on the first machine.

In step 415, the first missing or corrupted agent installed on the first machine may be redetected as shown by process block 110 in FIGS. 1 and 3. In some embodiments, the server may redetect the first missing or corrupted agent. In some embodiments, the agent repository 115 may be updated by increasing the detection count associated with the first missing or corrupted agent. Further, in some embodiments, a user of the first machine may be notified that the first machine has the first missing or corrupted agent. Still further, in some embodiments, a proponent of the first machine may be notified that the first machine has the first missing or corrupted agent.

In step 420, the redetected first missing or corrupted agent is automatically remediated by reimaging the first machine as shown by decision block 130 and process block 155 in FIGS. 1 and 3. In some embodiments, the automatic remediation machine may automatically remediate the redetected first missing or corrupted agent by reimaging the first machine. In some embodiments, the detection count associated with the redetected first missing or corrupted agent may meet a threshold prior to being automatically remediated by reimaging the first machine as shown by decision block 160 in FIGS. 1 and 3.

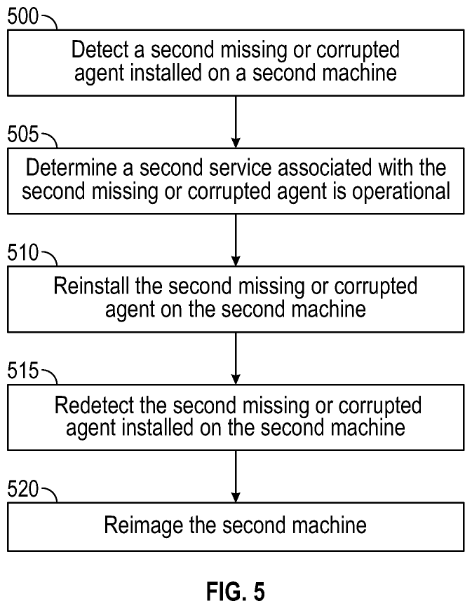

FIG. 5 also describes a method in accordance with one or more embodiments. In step 500, a second missing or corrupted agent installed on a second machine is detected as shown in process block 110 in FIGS. 1 and 3. In some embodiments, a server may detect the second missing or corrupted agent. In some embodiments, the second machine may be the first machine.

In step 505, a second service associated with the second missing or corrupted is determined to be operational as shown in decision block 135 in FIGS. 1 and 3. In some embodiments, the automatic remediation machine may determine the second service is operational.

In step 510, the second missing or corrupted agent is automatically remediated by reinstalling the second missing or corrupted agent on the second machine as shown by process block 150 in FIGS. 1 and 3. In some embodiments, the automatic remediation machine may automatically remediate the first missing or corrupted agent by reinstalling the second missing or corrupted agent on the second machine.

In step 515, the second missing or corrupted agent installed on the second machine may be redetected as shown by process block 110 in FIGS. 1 and 3. In some embodiments, the server may redetect the second missing or corrupted agent. In some embodiments, the agent repository 115 may be updated by increasing the detection count associated with the second missing or corrupted agent. Further, in some embodiments, a user of the second machine may be notified that the second machine has the second missing or corrupted agent. Still further, in some embodiments, a proponent of the second machine may be notified that the second machine has the second missing or corrupted agent.

In step 520, the redetected second missing or corrupted agent is automatically remediated by reimaging the second machine as shown by decision block 130 and process block 155 in FIGS. 1 and 3. In some embodiments, the automatic remediation machine may automatically remediate the redetected second missing or corrupted agent by reimaging the second machine. In some embodiments, the detection count associated with the redetected second missing or corrupted agent may meet a threshold prior to being automatically remediated by reimaging the second machine as shown by decision block 160 in FIGS. 1 and 3.

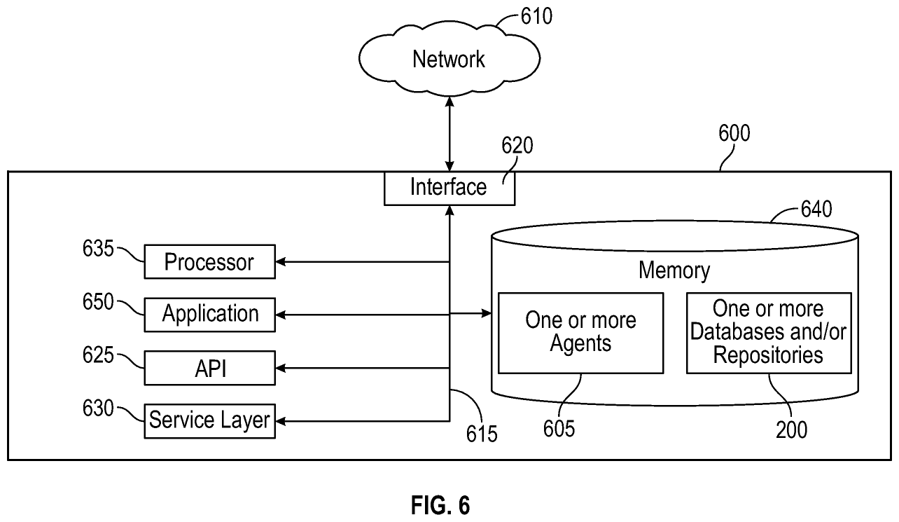

FIG. 6 illustrates a machine 600 in accordance with one or more embodiments. In some embodiments, one or more agents 605 may be installed on the machine 600. In some embodiments, the machine 600 may be an automatic remediation machine. Accordingly, the term “automatic remediation machine” may replace the term “machine” with respect to the discussion associated with FIG. 6 without departing from the scope of the disclosure. However, a person of ordinary skill in the art in the art will appreciate the machine 600 may be or include a server, computer system, or other electronic device without departing from the scope of the disclosure.

The machine 600 may be used to provide computational functionalities associated with described algorithms, methods, functions, processes, flows, and procedures as described in this disclosure, according to one or more embodiments. The illustrated machine 600 is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the machine 600 may include an input device, such as a keypad, keyboard, touch screen, or other device that can accept user information, and an output device that conveys information associated with the operation of the machine 600, including digital data, visual, or audio information (or a combination of information), or a GUI.

The machine 600 can serve in a role as a client, network component, a server, a database or other persistency, or any other component (or a combination of roles) of a computer system for performing the subject matter described in the instant disclosure. The illustrated machine 600 is communicably coupled with a network 610. In some implementations, one or more components of the machine 600 may be configured to operate within environments, including cloud-computing-based, local, global, or other environment (or a combination of environments).

At a high level, the machine 600 is an electronic computing device operable to receive, transmit, process, store, or manage data and information associated with the described subject matter. According to some implementations, the machine 600 may also include or be communicably coupled with an application server, e-mail server, web server, caching server, streaming data server, business intelligence (BI) server, or other server (or a combination of servers).

The machine 600 can receive requests over network 610 from a client application (for example, executing on another machine 600) and responding to the received requests by processing the said requests in an appropriate software application. In addition, requests may also be sent to the machine 600 from internal users (for example, from a command console or by other appropriate access method), external or third-parties, other automated applications, as well as any other appropriate entities, individuals, systems, or computer systems.

Each of the components of the machine 600 can communicate using a system bus 615. In some implementations, any or all of the components of the machine 600, both hardware or software (or a combination of hardware and software), may interface with each other or the interface 620 (or a combination of both) over the system bus 615 using an application programming interface (API) 625 or a service layer 630 (or a combination of the API 625 and service layer 630. The API 625 may include specifications for routines, data structures, and object classes. The API 625 may be either computer-language independent or dependent and refer to a complete interface, a single function, or even a set of APIs. The service layer 630 provides software services to the machine 600 or other components (whether or not illustrated) that are communicably coupled to the machine 600. The functionality of the machine 600 may be accessible for all service consumers using this service layer. Software services, such as those provided by the service layer 630, provide reusable, defined business functionalities through a defined interface. For example, the interface may be software written in JAVA, C++, or other suitable language providing data in extensible markup language (XML) format or another suitable format. While illustrated as an integrated component of the machine 600, alternative implementations may illustrate the API 625 or the service layer 630 as stand-alone components in relation to other components of the machine 600 or other components (whether or not illustrated) that are communicably coupled to the machine 600. Moreover, any or all parts of the API 625 or the service layer 630 may be implemented as child or sub-modules of another software module, enterprise application, or hardware module without departing from the scope of this disclosure.

The machine 600 includes an interface 620. Although illustrated as a single interface 620 in FIG. 6, two or more interfaces 620 may be used according to particular needs, desires, or particular implementations of the machine 600. The interface 620 is used by the machine 600 for communicating with other systems in a distributed environment that are connected to the network 610. Generally, the interface 620 includes logic encoded in software or hardware (or a combination of software and hardware) and operable to communicate with the network 610. More specifically, the interface 620 may include software supporting one or more communication protocols associated with communications such that the network 610 or interface's hardware is operable to communicate physical signals within and outside of the illustrated machine 600.

The machine 600 includes at least one computer processor 635. Although illustrated as a single computer processor 635 in FIG. 6, two or more processors 635 may be used according to particular needs, desires, or particular implementations of the machine 600. Generally, the computer processor 635 executes instructions and manipulates data to perform the operations of the machine 600 and any algorithms, methods, functions, processes, flows, and procedures as described in the instant disclosure.

The machine 600 also includes a memory 640 that stores software and information. Each software may be stored on the memory 640 of the machine 600 and associated with one or more agents 605. Further, the information may be stored in the one or more databases and/or repositories 200 further stored on the memory 640 of the machine 600. Although illustrated as a single memory 640 in FIG. 6, two or more memories 640 may be used according to particular needs, desires, or particular implementations of the machine 600 and the described functionality. While memory 640 is illustrated as an integral component of the machine 600, in alternative implementations, memory 640 can be external to the machine 600.

The application 650 is an algorithmic software engine providing functionality according to particular needs, desires, or particular implementations of the machine 600, particularly with respect to functionality described in this disclosure. For example, application 650 can serve as one or more components, modules, applications, etc. Further, although illustrated as a single application 650, the application 650 may be implemented as multiple applications 650 on the machine 600. In addition, although illustrated as integral to the machine 600, in alternative implementations, the application 650 can be external to the machine 600.

There may be any number of machines 600 associated with, or external to, a computer system containing a machine 600, wherein each machine 600 communicates over network 610. Further, the term “client,” “user,” and other appropriate terminology may be used interchangeably as appropriate without departing from the scope of this disclosure. Moreover, this disclosure contemplates that many users may use one machine 600, or that one user may use multiple machines 600.

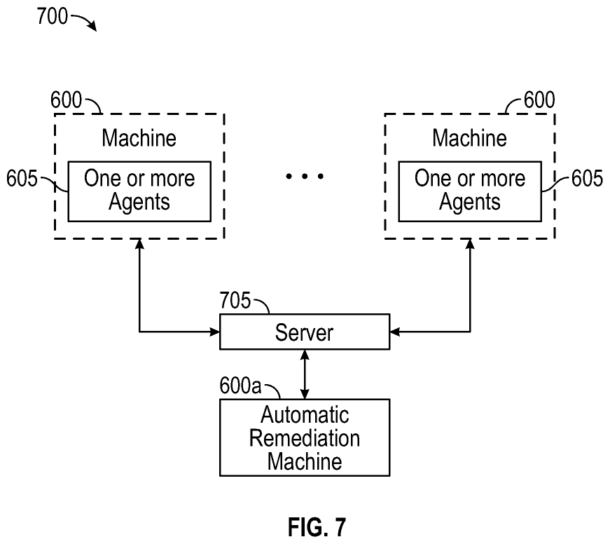

FIG. 7 illustrates a system 700 in accordance with one or more embodiments. The system 700 includes a server 705 and an automatic remediation machine 600a. The server 705 and automatic remediation machine 600a may be communicably coupled via the network 610 (not shown in FIG. 7).

The server 705 is further communicably coupled to each machine 600 with one or more agents 605 installed on each machine 600 via the network 610 (not shown in FIG. 7). The server 705 may detect and redetect one more missing or corrupted agents installed on one or more machines 600 as described in steps 400, 415, 500, and 515 in FIGS. 4 and 5. Accordingly, in some embodiments, the system 700 may further include the one or more machines 600. In some embodiments, each of the one or more agents 605 installed on each machine 600 may receive requests and/or updates from the server 705, such as security-related requests and status updates.

The automatic remediation machine 600a may perform steps 405, 410, 420, 505, 510, and 520 in FIGS. 4 and 5.

In summary, the disclosed data analytics methods and systems dynamically maintain one or more agents 605 installed on one or more machines 600 by automatically monitoring and remediating one or more missing or corrupted agents installed on one or more machines 600 by reading and writing information about each machine 600, each user of each machine 600, and/or each missing or corrupted agent to the one or more databases and/or repositories 200 that are used to make decisions as to how each missing or corrupted agent is to be automatically remediated.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A method of automatic remediation of a first missing or corrupted agent comprising:
detecting the first missing or corrupted agent installed on a first machine;
determining a first service associated with the first missing or corrupted agent is non-operational;
restarting the first service on the first machine,
wherein the automatic remediation comprises restarting the first service on the first machine;
redetecting the first missing or corrupted agent installed on the first machine; and
reimaging the first machine,
wherein the automatic remediation further comprises reimaging the first machine.

2. The method of claim 1, further comprising updating an agent repository comprising increasing a detection count associated with the first missing or corrupted agent by one.

3. The method of claim 2, wherein redetecting the first missing or corrupted agent comprises:
iteratively, until the detection count is greater than or equal to a threshold:
redetecting the first missing or corrupted agent installed on the first machine, and
updating the agent repository by increasing the detection count by one.

4. The method of claim 2, wherein updating the agent repository further comprises notifying a user of the first machine that the first machine has the first missing or corrupted agent.

5. The method of claim 2, wherein updating the agent repository further comprises notifying a proponent of the first machine that the first machine has the first missing or corrupted agent.

6. The method of claim 1, further comprising:
detecting a second missing or corrupted agent installed on a second machine;
determining a second service associated with the second missing or corrupted agent is operational; and
reinstalling the second missing or corrupted agent on the second machine,
wherein the automatic remediation further comprises reinstalling the second missing or corrupted agent on the second machine.

7. The method of claim 6, further comprising:
redetecting the second missing or corrupted agent installed on the second machine; and
reimaging the second machine,
wherein the automatic remediation further comprises reimaging the second machine.

8. The method of claim 1, wherein the first missing or corrupted agent comprises a first missing or corrupted security agent.

9. A method of automatic remediation of a first missing or corrupted agent comprising:
detecting the first missing or corrupted agent installed on a first machine;
determining a first service associated with the first missing or corrupted agent is operational;
reinstalling the first missing or corrupted agent on the first machine,
wherein the automatic remediation comprises reinstalling the first missing or corrupted agent on the first machine;
redetecting the first missing or corrupted agent installed on the first machine; and
reimaging the first machine,
wherein the automatic remediation further comprises reimaging the first machine.

10. The method of claim 9, further comprising:
detecting a second missing or corrupted agent installed on a second machine;
determining a second service associated with the second missing or corrupted agent is non-operational; and
restarting the second service on the second machine,
wherein the automatic remediation further comprises restarting the second service on the second machine.

11. The method of claim 10, further comprising:
redetecting the second missing or corrupted agent installed on the second machine; and
reimaging the second machine,
wherein the automatic remediation further comprises reimaging the second machine.

12. The method of claim 9, wherein the first missing or corrupted agent comprises a first missing or corrupted security agent.

13. A system comprising:
a server configured to detect a first missing or corrupted agent installed on a first machine, wherein the server is communicably coupled to the first machine; and
an automatic remediation machine configured to:
determine a first service associated with the first missing or corrupted agent is non-operational, and
restart the first service on the first machine,
wherein automatic remediation comprises to restart the first service on the first machine,
wherein the automatic remediation machine is communicably coupled to the server,
wherein the server is further configured to redetect the first missing or corrupted agent installed on the first machine; and
wherein the automatic remediation machine is further configured to reimage the first machine,
wherein the automatic remediation further comprises to reimage the first machine.

14. The system of claim 13, wherein the automatic remediation machine is further configured to update an agent repository comprising increasing a detection count associated with the first missing or corrupted agent by one.

15. The system of claim 14, wherein to redetect the first missing or corrupted agent comprises:
iteratively, until the detection count is greater than or equal to a threshold:
redetect the first missing or corrupted agent installed on the first machine, and
update the agent repository by increasing the detection count by one.

16. The system of claim 14, wherein to update the agent repository further comprises notifying a user of the first machine that the first machine has the first missing or corrupted agent.

17. The system of claim 14, wherein to update the agent repository further comprises notifying a proponent of the first machine that the first machine has the first missing or corrupted agent.

18. The system of claim 13, wherein the server is further configured to detect a second missing or corrupted agent installed on a second machine,
wherein the server is further communicably coupled to the second machine, and
wherein the automatic remediation machine is further configured to:
determine a second service associated with the second missing or corrupted agent is operational, and
reinstall the second missing or corrupted agent on the second machine,
wherein the automatic remediation further comprises to reinstall the second missing or corrupted agent on the second machine.

19. The system of claim 18, wherein the server is further configured to redetect the second missing or corrupted agent installed on the second machine,
wherein the automatic remediation machine is further configured to reimage the second machine, and
wherein the automatic remediation further comprises to reimage the second machine.

20. The system of claim 13, wherein the first missing or corrupted agent comprises a first missing or corrupted security agent.
